(19) United States
(12) Patent Application Publication
(10) Pub. No.: US 2005/0147033 A1
(43) Pub. Date: Jul. 7, 2005

(54) METHOD OF CONTROLLING DATA FLOW FOR A MEDIA PLAYER SYSTEM

(76) Inventors: Yi-Lon Chin, Taipei Hsien (TW); Chang-Hung Lee, Yun-Lin Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/904,049

(22) Filed: Oct. 21, 2004

(30) Foreign Application Priority Data
Oct. 31, 2003 (TW) 092130566

(51) Int. Cl. H04L 1/00

(52) U.S. Cl. 370/229

(57) ABSTRACT

A data control method used in a media player system is disclosed. The media player system includes a data end and a play end connected to each other through a network. The data end includes an encoder for encoding media data. The play end includes a buffer for storing media data packets. The method includes comparing the number of media data packets stored in the buffer with a high threshold and a low threshold, decelerating the encoding by the encoder of the data end if the number of media data packets stored in the buffer is larger than the high threshold, and accelerating the encoding by the encoder of the data end if the number of media data packets stored in the buffer is smaller than the high threshold.

### BACKGROUND OF INVENTION

1. Field of the Invention

The present invention relates to a media player system, and more specifically, to a method for controlling a media player system by utilizing data flow control and dynamically controlling the threshold of media data packets stored in a buffer.

2. Description of the Prior Art

As network transmission technology progresses, music and videos that can be played on the Internet become indispensable to the society. However, playing music and videos online is extremely influenced by the bandwidth and transmission quality of the network. As for the specification of Internet, the bandwidth for each user can never be fixed; that is, the bandwidth provided by an ISP (internet service provider) is a theoretical maximum. For instance, ADSL/Cable (360 Kbps/sec) may be under 100 Kbps when the line is busy; 56 Kbps modem may be less than 28 Kbps. Even when the line is not busy, there will be a difference of ±10%-30%. In wireless network, multiple access is utilized to share the bandwidth so that the real bandwidth is unpredictable.

In addition, unstable connection rate also influences the playing of online music and videos. It is possible to download the file to play on a personal computer, but in case of a movie with a playing length of 1 or 2 hours, downloading will take an extremely long time.

A data stream channel has been developed to solve this problem. Please refer to FIG. 1 showing a block diagram of a conventional online media player system 10. The media player system 10 includes a data end 12 and a play end 14. The data end 12 includes an encoder 22 for encoding media data packets to be transmitted to the play end 14. The play end 14 is connected to the data end 12 through a network 20. The play end 14 includes a buffer 16 for storing the media data packets, and a decoder 18 for decoding the media data packets stored in the buffer 16. Before playing the media data at the data end 12, the play end 14 downloads a part of media data and stores them into the buffer 16, and then the play end 14 plays the media data packets stored in the buffer 16. After transmitting all the packets, the data end 12 generates a stop signal to notify the play end 14 to stop playing the media data packets. However, if the data end 12 interrupts the transmission without notice, after the play end 14 has played all the packets stored in the buffer 16, the play end 14 cannot determine whether all the packets that are to be transmitted have been received because no stop signal was sent. As a result, the play end 14 will repeatedly play the last packet stored in the buffer 16. Since most of the packets have been decoded and played, only a few packets will be repeated again and again, which causes noise.

Therefore, according to the prior art, the play end 14 generates a probe packet periodically. If the probe packet transmission fails or stops, the transmission interruption of the data end 12 can be recognized, and the play end 14 will stop playing and clear the buffer 16. However, if the period of probe packet transmission is too long, the effective bandwidth of the network 20 will be reduced, and if the period is too short, the status of the data end 12 cannot be known.

### SUMMARY OF INVENTION

It is therefore a primary objective of the present invention to provide a method for controlling a media player system by utilizing data flow control and dynamically controlling the threshold of media data packets stored in a buffer in order to solve the problems in the prior art.

Briefly summarized, a data control method used in a media player system is disclosed. The media player system includes a data end and a play end connected to each other through a network. The data end includes an encoder for encoding media data. The play end includes a buffer for storing media data packets. The method includes comparing the number of media data packets stored in the buffer with a high threshold and a low threshold, decelerating the encoding rate of the encoder in the data end if the number of media data packets stored in the buffer is larger than the high threshold, and accelerating the encoding rate of the encoder in the data end if the number of media data packets stored in the buffer is smaller than the high threshold.

The present invention further provides a data control method used in a media player system. The media player system includes a data end and a play end connected to each other through a network. The data end includes an encoder for encoding media data and transmitting a plurality of media data packets to the play end. The play end includes a buffer for storing the media data packets, a decoder for decoding the media data packets stored in the buffer, and a logic unit. The method includes comparing the number of media data packets stored in the buffer with a high threshold and a low threshold. If the number of media data packets stored in the buffer is smaller than the low threshold, the logic unit generates predetermined packets and storing it into the buffer. The decoder reads and plays the predetermined packets until media data packets stored in the buffer higher then the low threshold and the logic unit stops generating the predetermined packets.

The present invention also provides a data control method used in a media player system. The media player system includes a data end and a play end connected to each other through a network. The data end includes an encoder for encoding media data. The play end includes a buffer for storing media data packets. The method includes dynamically adjusting a high threshold and a low threshold of the buffer. When detecting the available transmission bandwidth is higher than a predetermined parameter, both the high threshold and the low threshold can be increased. When detecting the available transmission bandwidth is lowering than a predetermined parameter, both the high threshold and the low threshold can be decrease. Also, if detecting the media data transmission rate from the data end is unstable, increasing the high threshold and decreasing the low threshold. If detecting the media data transmission rate from the data end is stable, decreasing the high threshold and increasing the low threshold. The object of adjusting the high threshold and the low threshold is to make efficiently using the buffer.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a conventional online media player system.

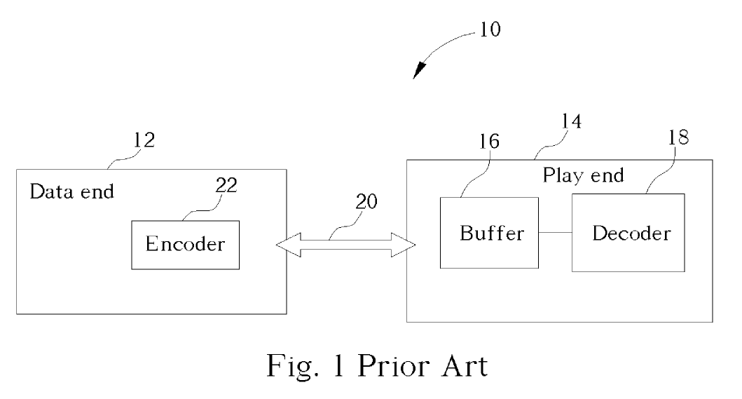

FIG. 2 is a block diagram of a media player system according to the present invention.

FIG. 3 is a flow chart of data flow control by the media player system according to the present invention.

FIG. 4 illustrates the changing of the number of media data packets stored in the buffer.

FIG. 5 illustrates how to adjust the high threshold H(t) and the low threshold L(t) dynamically according to data flow N(t) of the network.

### DETAILED DESCRIPTION

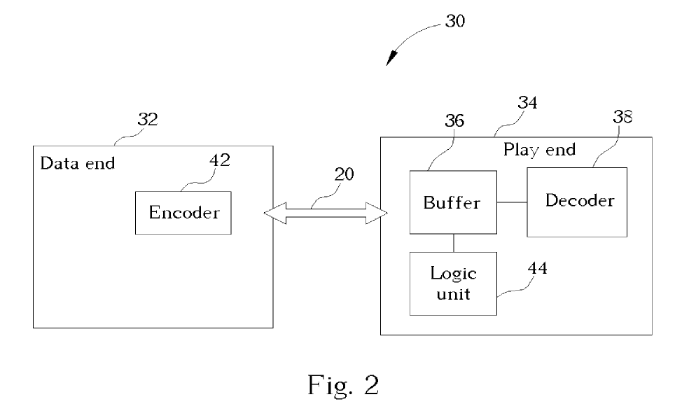

Please refer to FIG. 2 showing a block diagram of a media player system 30 according to the present invention. The media player system 30 includes a data end 32 and a play end 34 connected through a network 20. The data end 32 includes an encoder 42 for encoding media data packets to be transmitted to the play end 34. The play end 34 includes a buffer 36 for storing the media data packets and a decoder 38 for decoding the media data packets. Before playing the media data at the data end 32, the play end 34 downloads a part of media data and stores them into the buffer 36, and then the play end 34 plays the media data packets stored in the buffer 36.

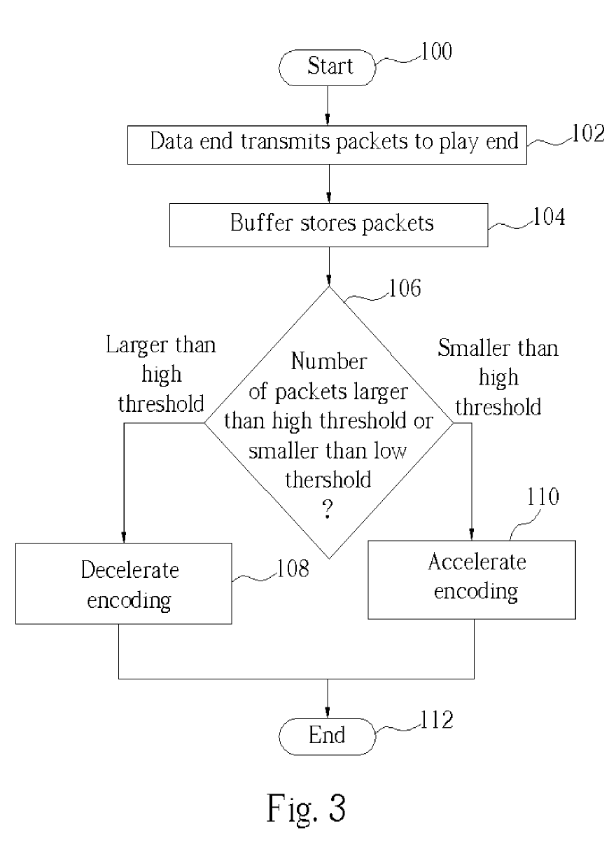

Please refer to FIG. 3 showing a flow chart of data flow control by the media player system 30 according to the present invention as follows:

Step 100: Start.

Step 102: The data end 32 transmits the media data packets to the play end 34.

Step 104: The buffer 36 of the play end 34 stores the media data packets from the data end 32.

Step 106: Compare the number of the packets stored in the buffer 36 with a high threshold and a low threshold. If the number is larger than the high threshold, transmit a first control signal to the data end 32 and proceed to Step 108. If the number is smaller than the low threshold, transmit a second control signal to the data end 32 and proceed to Step 110.

Step 108: When the data end 32 receives the first control signal, the encoder 42 slows down its encoding rate.

Step 110: When the data end 32 receives the second control signal, the encoder 42 accelerates its encoding rate.

Step 112: End.

The operation of the media player system 30 is described as follows. When the play end 34 is required to play media data (e.g. MP3, MPEG files) stored in the data end 32 through the network 20, the data end 32 transmits media data packets to the play end 34 through the network by using a protocol such as the 802.11b protocol. The play end 34 stores the packets into the buffer 36, and then decodes the packets in sequence with the decoder 38. Because the transmission rate of the network is not stable, especially in case of wireless network, the number of the media data packets stored in the buffer 36 changes all the time; therefore, the play end 34 further includes a logic unit 44 to periodically detect the number of media data packets stored in the buffer 36. During a predetermined time period, the number of the packets received from network 20 is higher than the play rate of the play end 34, an overflow in the buffer 36 will occur. In order to prevent overflow at the buffer 36, the logic unit 44 compares the number of packets with a high threshold H(t). When detecting the number of packets stored in the buffer 36, if the number of packets is larger than the high threshold H(t), the logic unit 44 generates a first alarm signal to the data end 32. In response the encoder 42 of the data end 32 will slow down encoding, which decreases the number of encoded packets transmitted through the network 20 and accordingly, decreases the number of packets stored in the buffer 36. On the other hand, during the predetermined time period, the number of the packets received from network 20 is less than play rate of the play end 34, the play end 34 will play packets still in the buffer 36 repeatedly causing noise. In order to prevent the packets from being played repeatedly, the logic unit 44 compares the number of packets with a low threshold L(t). When detecting the number of packets stored in the buffer 36, if the number of packets is smaller than the low threshold L(t), the logic unit 44 generates a second alarm signal to the data end 32. In response the encoder 42 of the data end 32 will speed up encoding, which increases the number of encoded packets transmitted through the network and accordingly, increases the number of packets stored in the buffer 36. In the case that the network is busy, meaning that the packets cannot be completely transmitted successfully, the number of packets stored in the buffer 36 will be smaller than the low threshold L(t). In this case, the logic unit 44 inserts dummy packets into the buffer 36. The play end 34 then plays the dummy packets instead of the media data packets stored in the buffer 36 until the number of packets stored in the buffer 36 becomes larger than the low threshold L(t). The dummy packets may be a mute audio. At that point, the logic unit 44 will stop inserting dummy packets into the buffer 36. In such a manner, the media player system 30 can prevent the overflow of the buffer 36 or noises caused by repeated playing of the packets in the buffer 36. If the media data packets being decoded as a video, the dummy packets can be decoded as a still image.

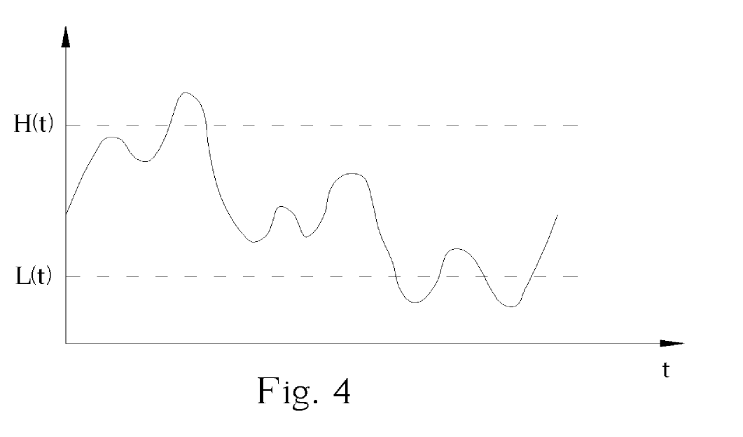

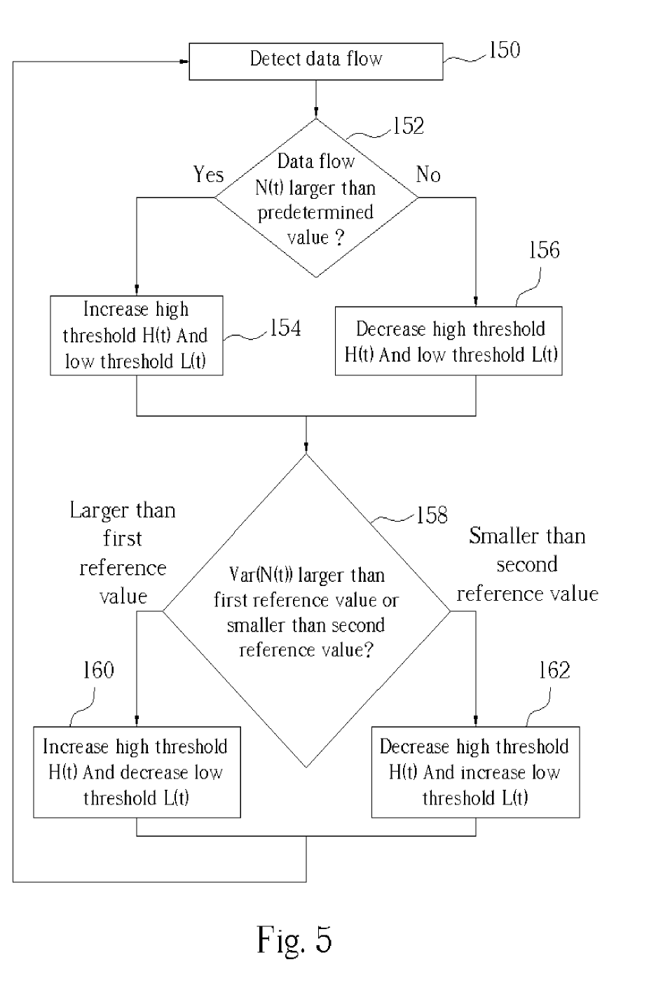

Please refer to FIG. 4 showing the changing of the number of media data packets stored in the buffer 36. As described above, the high threshold H(t) and the low threshold L(t) are the key points in controlling the packet transmission. Therefore, it is important to determine the proper values for the high threshold H(t) and the low threshold L(t). Please refer to FIG. 5 showing how to adjust the high threshold H(t) and the low threshold L(t) dynamically according to data flow N(t) of the network. The steps are as follows:

Step 150: Detect the data flow N(t) of the network.

Step 152: Determine whether the data flow N(t) is larger than a predetermined value. If yes, proceed to Step 154, and if no, proceed to Step 156.

Step 154: If the data flow N(t) is larger than the predetermined value, increase both the high threshold H(t) and the low threshold L(t).

Step 156: If the data flow N(t) is smaller than the predetermined value, decrease both the high threshold H(t) and the low threshold L(t).

Step 158: Calculate the variance Var(N(t)) of the data flow N(t). If the variance Var(N(t)) is larger than a first reference value, proceed to Step 160, and if the variance Var(N(t)) is smaller than a second reference value, proceed to Step 162.

Step 160: Increase the high threshold H(t) and decrease the low threshold L(t).

Step 162: Decrease the high threshold H(t) and increase the low threshold L(t).

In order to adjust the high threshold H(t) and the low threshold L(t) dynamically according to the effective data flow of the network 20, the logic unit 44 periodically detects the effective data flow N(t) of the network 20. When the data flow of the network 20 is larger than the predetermined value, the data end 32 can send more packets to the network 20, meaning that threshold H(t) and the low threshold L(t) can be increased. On the other hand, if the effective data flow N(t) of the network 20 is smaller than the predetermined value, the data end 32 is sending too many packets to the network 20, meaning that threshold H(t) and the low threshold L(t) needs to be decreased.

Besides the effective data flow N(t) of the network, the variation of data flow N(t) needs to be considered. If the variation of data flow N(t) is unstable, then the high threshold H(t) and the low threshold L(t) will be adjusted too frequently. Therefore, the logic unit 44 detects periodically the variance Var(N(t)) of the data flow N(t) over a predetermined period of time. If the variance Var(N(t)) is larger than the first reference value, then the high threshold H(t) and the low threshold L(t) are too close to each other, meaning that the values of the high threshold H(t) and the low threshold L(t) are changed too frequently. In this case, it is required to increase the high threshold H(t) and decrease the low threshold L(t). On the otherhand, if the variance Var(N(t)) is smaller than the second reference value, the high threshold H(t) and the low threshold L(t) are too far from each other, meaning that the variation of the high threshold H(t) and the low threshold L(t) cannot be adjusted in real-time. In this case, it is required to decrease the high threshold H(t) and increase the low threshold L(t). As a result, the memory space can be properly released.

From Step 100 to Step 112, the number of media data packets stored in the buffer 36 is compared with the high threshold and the low threshold to control the encoding rate of the data end 32 in order to prevent overflow of the buffer 36 or the repeated playing of remaining packets, which causes noise. From Step 152 to Step 162, the high threshold and the low threshold can be adjusted dynamically so that the encoding rate of the encoder 22 and the transmission rate of the network 20 can be adjusted according to the number of media data packets stored in the buffer 36.

In contrast to the prior art, the present invention controls the media data packet transmission rate by detecting the number of packets stored in the buffer. When the number of packets stored in the buffer is larger than the high threshold, the encoding rate of the data end is slowed down, and when the number of packets stored in the buffer is smaller than the high threshold, the encoding rate of the data end is sped up, or the transmission rate of the network is increased. Furthermore, the high threshold and the low threshold can be dynamically adjusted by detecting whether the network transmission rate is larger or smaller than the predetermined value. Moreover, when the variance of network transmission rate is larger than a value, or the variation of the high threshold and the low threshold is too frequent, the distance between the high threshold and the low threshold can be adjusted according to the number of packets stored in the buffer. Therefore, the media player system according to the present invention only requires a smaller buffer space to smoothly play media data.

Those skilled in the art will readily observe that numerous modifications and alterations of the method may be made while retaining the teachings of the invention. Accordingly, the above disclosure should be construed as limited only by the metes and bounds of the appended claims.

1. A data control method used in a media player system, the media player system comprising a data end and a play end connected by a network, the data end comprising an encoder for encoding media data packets and transmitting them through the network to the play end, the play end comprising a buffer for storing received media data packets, the method comprising:
comparing a number of media data packets stored in the buffer with a high threshold and a low threshold;
decelerating an encoding rate of the encoder if the number of media data packets stored in the buffer being larger than the high threshold; and
accelerating the encoding rate of the encoder if the number of media data packets stored in the buffer is smaller than the low threshold.

2. The method of claim 1 further comprising:
detecting a media data transmission rate from the data end to the play end;
increasing the high threshold and the low threshold of the buffer if the media data transmission rate being larger than a predetermined value; and
decreasing the high threshold and the low threshold of the buffer if the media data transmission rate being smaller than the predetermined value.

3. The method of claim 1 further comprising:
detecting a variance of a media data transmission rate from the data end to the play end;
increasing the high threshold and decreasing the low threshold if the variance being larger than a first reference value, and decreasing the high threshold and increasing the low threshold if the variance being smaller than a second reference value.

4. The method of claim 1 wherein the media data transmitted from the data end to the play end is in video format.

5. The method of claim 4 wherein the video format is an MPEG format.

6. The method of claim 1 wherein the media data transmitted from the data end to the play end is in audio format.

7. The method of claim 6 wherein the audio format is an MP3 format.

8. The method of claim 6 further comprising:
stopping playing the media data packets stored in the buffer and playing a mute audio if the number of media data packets is smaller than the low threshold.

9. The method of claim 1 wherein the network between the data end and the play end is a wireless network.

10. A data control method used in a media player system, the media player system comprising a data end and a play end, the data end connected to the play end through a network, the data end comprising an encoder for encoding media data packets and transmitting a plurality of media data packets to the play end, the play end comprising a buffer for storing the received media data packets, a decoder for decoding the media data packets stored in the buffer, and a logic unit, the method comprising:
comparing a number of media data packets stored in the buffer with a high threshold and a low threshold;
generating a plurality of predetermined packets by the logic unit and storing the predetermined packets into the buffer if the number of media data packets stored in the buffer being smaller than the low threshold;
reading and playing the predetermined packets by the decoder; and
stopping generating the predetermined packets if the number of media data packets stored in the buffer being larger than the low threshold.

11. The method of claim 10 further comprising:
notifying the encoder by the logic unit to decelerate encoding if the number of media data packets stored in the buffer being larger than the high threshold; and
notifying the encoder with the logic unit to accelerate encoding if the number of media data packets stored in the buffer being smaller than the low threshold.

12. The method of claim 10 wherein the media data packets transmitted from the data end to the play end is in video format, and the predetermined packets comprise a still image.

13. The method of claim 10 wherein the media data transmitted from the data end to the play end is in audio format, and the predetermined packets being a mute audio.

14. A data control method used in a media player system, the media player system comprising a data end and a play end, the data end connected the play end through a network, the data end comprising an encoder for encoding media data packets, the play end comprising a buffer for storing media data packets, and the method comprising:
setting up a high threshold and a low threshold of the buffer, and comparing the number of media data packets stored in the buffer with the high threshold and the low threshold in order to adjust the encoding rate of the encoder;
detecting whether the media data transmission rate from the data end to the play end being larger than a predetermined value;
increasing the high threshold and decreasing the low threshold if the media data transmission rate from the data end to the play end is larger than the predetermined value; and
decreasing the high threshold and increasing the low threshold if the media data transmission rate from the data end to the play end is smaller than the predetermined value.

15. The method of claim 14 further comprising decelerating the encoding rate by the encoder of the data end if the number of media data packets stored in the buffer is larger than the high threshold, and accelerating the encoding rate by the encoder of the data end if the number of media data packets stored in the buffer is smaller than the high threshold.

16. The method of claim 14 further comprising detecting the variance of the media data transmission rate from the data end to the play end, increasing the high threshold and decreasing the low threshold if the variance is larger than a first reference value, and decreasing the high threshold and increasing the low threshold if the variance is smaller than a second reference value.
